(19) United States
(12) Patent Application Publication
(10) Pub. No.: US 2006/0137512 A1
(43) Pub. Date: Jun. 29, 2006

(54) Musical notation system for piano, organ and keyboard

(76) Inventor: Martin Lassar, Oceanside, CA (US)

Correspondence Address: Law Office of Kenneth P. Krohn, Suite 320, 2131 Palomar Airport Road, Carlsbad, CA, 92009, US

(21) Appl. No.: 11/024,341

(22) Filed: Dec. 28, 2004

(51) Int. Cl. G09B 15/02

(52) U.S. Cl. 84/483.2

(57) ABSTRACT

The present invention is generally comprised of a system of musical notation for playing the piano, organ or keyboard. One version of the invention is a system generally comprised of at least one keyboard diagram that accompanies a musical composition. The keyboard diagram displays the fingering to be used by the player of the piano, organ or keyboard that corresponds to the musical composition. Other versions of the invention generally include articles that are comprised of a keyboard diagram and keyboard diagram attachment means that are used to attach the keyboard diagram to the display medium on which a musical composition is displayed. Other versions of the invention generally comprise a method of using these articles. Other versions generally comprise stamping appliances that may be used to place a facsimile keyboard diagram on the display medium on which the musical composition is displayed. Finally, other versions of the invention generally comprise methods of using these stamping appliances.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

The present invention generally relates to a musical notation system for the piano, organ and keyboard, and more specifically, to a musical notation system, articles, appliances and methods that provide a keyboard diagram that accompanies a musical composition for playing the piano, organ and keyboard.

In playing musical compositions for the piano, organ or keyboard, the player may occasionally come across portions of the musical composition for which he or she does not know the appropriate fingering for a note or chord. This is especially true in cases involving students and less accomplished players. Where the player desires to know the appropriate fingering, he or she is usually required to stop playing the music and look up the fingering in a book or other source that provides instruction in playing the piano, organ or keyboard. In addition to breaking the continuity and flow of the music, this requirement may cause the player to become inconvenienced and frustrated as well. In some cases, the player may not be able to locate the appropriate source to determine the correct fingering at all, further increasing frustration.

There currently exist in the relevant art musical notation systems that may be used to assist in playing the piano, organ or keyboard. Many of these systems are relatively complex, making them difficult to use. Others involve instructional notation that is separate from the musical composition to be played. For example, some systems have a series of keyboard diagrams that accompany the musical composition (staff, clefts, notes, chords, and similar notations) that is to be played, but the diagrams are grouped together and placed before or after the musical composition (or both) on the sheet of music or other medium. In other cases, the keyboard diagrams may be placed on a different page. If the player doesn't know the fingering for a particular note or chord while playing the music, he or she must look away from the music to the grouping of diagrams to determine the correct finger position on the piano, organ or keyboard to play the note or chord. This is inconvenient and may be frustrating for the player because the player must search through the grouping of keyboard diagrams to determine which corresponds to the desired note or chord. In some cases, the player must even turn to a different page to find the keyboard diagrams. In addition, by looking away from the music, the continuity of playing the music is broken so that the music does not flow as intended. Further, once the desired fingering is determined from evaluation of the grouping of diagrams, the player must then search the music to determine where he or she left off. This is also inconvenient and may be frustrating as well. As a result, there is a need for a system of musical notation for the piano, organ and keyboard that will avoid these problems, making it simple, fast, easy and visually convenient to determine the fingering for a particular chord or note in the music to be played. Such a system would be convenient, lessen frustration, and provide for greater continuity in playing the desired music.

### SUMMARY

The present invention is directed to a system, articles and methods of musical notation for the piano, organ and keyboard that meet the needs discussed above in the Background section. As described in greater detail below, the present invention, when used for its intended purposes, has many advantages over other systems known in the art, as well as novel features that result in a new musical notation system, articles and methods that are not anticipated, rendered obvious, suggested, or even implied by any prior art systems, devices or methods, either alone or in any combination thereof.

One embodiment of a first version of the present invention generally discloses a system of musical notation for playing the piano, organ or keyboard. In this embodiment of the first version of the invention, the system comprises a musical composition for playing the piano, organ or keyboard and at least one keyboard diagram. In this embodiment, the musical composition is comprised of at least one staff that is displayed on a display medium. The at least one keyboard diagram is positioned on the display medium above or below each at least one staff and displays the piano, organ or keyboard fingering for the portion of the musical composition corresponding to the position of the at least one staff where the at least one keyboard is positioned. Alternatively, the at least one keyboard diagram may be positioned on the display medium in any combination of above and below the at least one staff. In other embodiments of this first version of the invention, the portion of the musical composition to which the at least one keyboard diagram corresponds is comprised of at least one musical note depicted on the at least one staff. In yet other embodiments, the display medium is comprised of an electronic display, such as a cathode ray tube, light emitting diode, liquid crystal display, or any combination thereof. In still other embodiments, the display medium is comprised of any material having a surface suitable for permanent recordation of musical compositions, such as woods, papers, metals, polymers, fabrics, or any combination of such materials.

In some embodiments of this first version of the invention, the musical composition further comprises at least one chord designation that is positioned above or below each at least one staff on the display medium. Alternatively, the at least one chord designation may be positioned on the display medium in any combination of above and below the at least one staff. In these embodiments, the portion of the musical composition to which the at least one keyboard diagram corresponds may be comprised of one of the chord designations. In other embodiments, the at least one keyboard diagram is comprised of diagrams depicting at least seven white keys and at least five black keys in the form of a keyboard. In still other embodiments, the at least one keyboard diagram is comprised of diagrams depicting not more than 11 white keys and not more than eight black keys in the form of a keyboard. In some other embodiments, the at least one keyboard diagram is comprised of diagrams depicting 11 white keys and eight black keys in the form of a keyboard. In some embodiments of this first version of the invention, the piano, organ or keyboard fingering corresponding to the musical composition is depicted on the keyboard diagram in the form of at least one mark on at least one of the keys on the at least one keyboard diagram. In other embodiments, there are at least two keyboard diagrams, wherein a first keyboard diagram corresponds to an earlier movement of the musical composition than a second keyboard diagram. In some of these embodiments, the at least one mark depicted on the second keyboard diagram may have a different appearance if the fingering corresponding to such at least one mark is the same as in the immediately preceding first keyboard diagram. In some of these embodiments, each mark depicted on a second keyboard diagram that has the same piano, organ or keyboard fingering as in the immediately preceding first keyboard diagram is in the form of an annulus and other marks are in the form of a circle.

Thus, the piano, organ or keyboard player may observe the appropriate keyboard fingering directly above the music that is being played. There is no need to look away from the music to find the appropriate fingering. Similarly, there is no need to look through a grouping of keyboard diagrams to see which one corresponds to the desired music, and there is no need to turn the page. The player may therefore easily and conveniently determine the appropriate fingering without the need to stop the flow of the music. The system consequently meets the needs described above in the Background section. In addition, in the embodiments where different marks are used to depict the appropriate fingering, the player may immediately see which fingers need to be repositioned to different keys, and which fingers need to be left on the same keys, to play the next portion of music. This makes playing even simpler and provides for even less pause in playing the music. It also makes the learning of new chords and notes simpler because the commonality of different chords and notes is graphically emphasized.

One embodiment of a second version of the present invention is an article that provides musical notation for playing the piano, organ or keyboard. In this embodiment, the article comprises a keyboard diagram and keyboard diagram attachment means. The keyboard diagram is attached by the keyboard diagram attachment means to a display medium on which is displayed a musical composition for playing the piano, organ or keyboard. The musical composition is comprised of at least one staff that is displayed on the display medium. The keyboard diagram is positioned on the display medium above or below, or any combination of above and below, each at least one staff. In other embodiments of this second version of the invention, the keyboard diagram attachment means is comprised of the group consisting of glue, adhesive, paste, epoxy, adhesive tape, stitching, static electrification, or any combination of such means. In still other embodiments, the keyboard diagram is comprised of the group consisting of papers, polymers, plastics, metal foils, wood, cloth, fabric, synthetic materials, natural materials, or any combination of such materials. In yet other embodiments, the keyboard diagram displays the piano, organ or keyboard fingering for the portion of the musical composition corresponding to the position of the at least one staff where the keyboard is positioned. In some of these embodiments, the keyboard diagram displays the chord designation corresponding to the fingering. Thus, the second version of the invention provides a means for the player to add the type of keyboard diagrams described above in conjunction with the first version of the invention to an existing musical composition that does not have them.

One embodiment of a third version of the present invention is also an article that provides musical notation for playing the piano, organ or keyboard. In this embodiment of the third version of the invention, the article is comprised of a musical composition for playing the piano, organ or keyboard that is displayed on a display medium, at least one keyboard diagram, and keyboard diagram attachment means. In this embodiment, the musical composition is comprised of at least one staff that is displayed on the display medium. The at least one keyboard diagram is attached by the keyboard diagram attachment means to the display medium and is positioned on the display medium above or below each at least one staff. Alternatively, the at least one keyboard diagram may be positioned on the display medium in any combination of above and below the at least one staff. In other embodiments of this third version of the invention, the at least one keyboard diagram is positioned on the display medium above or below, or any combination of above and below, each at least one staff and displays the piano, organ or keyboard fingering for the portion of the musical composition corresponding to the position of the at least one staff where the at least one keyboard is positioned.

One embodiment of a fourth version of the present invention is also an article that provides musical notation for playing the piano, organ or keyboard. In this embodiment, the article comprises at least one keyboard diagram, keyboard diagram attachment means, a support member, and support attachment means. The at least one keyboard diagram is attached by the keyboard diagram attachment means to a display medium on which is displayed a musical composition for playing the piano, organ or keyboard. The musical composition is comprised of at least one staff that is displayed on the display medium and the at least one keyboard diagram is positioned on the display medium above or below each at least one staff. Alternatively, the at least one keyboard diagram may be positioned on the display medium in any combination of above and below the at least one staff. The at least one keyboard diagram is removably attached to the support member by using the support attachment means. In some embodiments of this fourth version of the invention, the at least one keyboard diagram is comprised of the group consisting of papers, polymers, plastics, metal foils, wood, cloth, fabric, synthetic materials, natural materials, or any combination of such materials. In other embodiments, the keyboard diagram attachment means is comprised of an adhesive, the support attachment means is comprised of the same adhesive, and the support member is comprised of a material that may be removably attached to the adhesive. In still other embodiments, the adhesive is a pressure-sensitive adhesive applied to the bottom surface of the at least one keyboard diagram and the support member is comprised of a poly-coated layflat release liner that may be peeled away from the adhesive. In yet other embodiments of this fourth version of the invention, the support member is of a size adapted so that at least two keyboard diagrams may be removably attached to the support member using the support attachment means. In some of these embodiments, the support member is comprised of a flexible or semi-flexible material that is elongated so that at least two keyboard diagrams may be removably attached to the support member along its longitudinal axis. In these embodiments, the support member may be rolled up in the form of a roll. In other embodiments, the keyboard diagram displays the piano, organ or keyboard fingering for the portion of the musical composition corresponding to the position of the at least one staff where the keyboard diagram is positioned. Thus, the fourth version of the invention provides an even more convenient means for the player to add the type of keyboard diagrams described above in conjunction with the second version to an existing musical composition that does not have them.

One embodiment of a fifth version of the invention is a method of using various embodiments of the article of the fourth version of the invention, as described above. In this embodiment, the method comprises the steps of removing at least one keyboard diagram from the support member, and attaching the at least one keyboard diagram to the display medium using the keyboard diagram attachment means in a manner so that the at least one keyboard diagram is positioned on the display medium above or below the at least one staff. In other embodiments, the method further comprises the step of displaying or placing on the at least one keyboard diagram the piano, organ or keyboard fingering for the portion of the musical composition corresponding to the position of the at least one staff where the keyboard is positioned.

One embodiment of a sixth version of the present invention is a stamping appliance that provides musical notation for playing the piano, organ or keyboard. In this embodiment, the stamping appliance is comprised of a stamping member. In other embodiments, the stamping appliance is further comprised of an ink blotting pad member having a blotting surface saturated with ink. The stamping member is further comprised of a handle portion and a stamping portion, wherein the stamping portion has a raised keyboard diagram pattern on a bottom stamping surface thereof. Also in this embodiment, the bottom stamping surface of the stamping portion is placed adjacent to the blotting surface of the ink blotting pad member so that the raised keyboard diagram pattern on the bottom stamping surface is coated with a layer of ink. The stamping portion is then removed from the ink blotting pad member. In this embodiment, a keyboard diagram is placed on a display medium on which is displayed a musical composition for playing the piano, organ or keyboard by placing the raised keyboard diagram pattern on the bottom stamping surface adjacent to the surface of the display medium in a manner so that an ink facsimile of the raised keyboard diagram pattern is left on the display medium when the raised keyboard diagram pattern on the bottom stamping surface is removed from the display medium. The facsimile keyboard diagram is positioned on the display medium above or below, or any combination of above and below, at least one staff that comprises the musical composition that is displayed on the display medium. In another embodiment of this sixth version of the invention, the raised keyboard diagram pattern on the bottom stamping surface of the stamping portion further comprises the piano, organ or keyboard fingering for the portion of the musical composition corresponding to the position of the at least one staff where the facsimile keyboard is positioned.

One embodiment of a seventh version of the present invention is a method of using the embodiment of the stamping appliance described above under the sixth version of the invention. In this embodiment, the method comprises the following steps. First, the bottom stamping surface of the stamping portion is placed adjacent to a blotting surface of the ink blotting pad member in a manner so that the raised keyboard diagram pattern on the bottom stamping surface is coated with a layer of ink. Second, the bottom stamping surface of the stamping portion is removed from the ink blotting pad member. Third, the raised keyboard diagram pattern of the bottom stamping surface of the stamping member is momentarily placed adjacent to the surface of a display medium on which is displayed a musical composition for playing the piano, organ or keyboard, wherein the musical composition is comprised of at least one staff that is displayed on the display medium, and wherein the raised keyboard diagram pattern is positioned above or below the at least one staff on the display medium. Fourth, the raised keyboard diagram pattern on the bottom stamping surface of the stamping appliance is removed from the surface of the display medium in a manner so that an ink facsimile of the raised keyboard diagram pattern is left on the display medium when the raised keyboard diagram pattern on the bottom stamping surface is removed from the display medium. In other embodiments of the seventh version of the invention, the method further comprises the step of placing the piano, organ or keyboard fingering for the portion of the musical composition corresponding to the position of the at least one staff where the facsimile keyboard diagram is positioned on the facsimile keyboard diagram.

An embodiment of an eighth version of the present invention is also a stamping appliance that provides musical notation for playing the piano, organ or keyboard. In this embodiment, the stamping appliance comprises a handle portion having an ink source and a stamping portion having a keyboard diagram pattern on a bottom stamping surface thereof. Also in this embodiment, the bottom stamping surface of the stamping portion is positioned at one end of the handle adjacent to a surface of the ink source, so that there is a layer of ink on the keyboard diagram pattern on the bottom stamping surface as a result of the stamping portion being in physical contact with the ink source. In this embodiment, a keyboard diagram is placed on a display medium on which is displayed a musical composition for playing the piano, organ or keyboard by placing the keyboard diagram pattern on the bottom stamping surface adjacent to the surface of the display medium in a manner so that an ink facsimile of the keyboard diagram pattern is left on the display medium when the keyboard diagram pattern on the bottom stamping surface is removed from the display medium. The keyboard diagram is positioned on the display medium above or below, or any combination of above and below, at least one staff that comprises the musical composition that is displayed on the display medium. In another embodiment of this eighth version of the invention, the keyboard diagram pattern on the bottom stamping surface of the stamping portion further comprises the piano, organ or keyboard fingering for the portion of the musical composition corresponding to the position of the at least one staff where the facsimile keyboard is positioned.

An embodiment of a ninth version of the present invention is a method of using the embodiments of the stamping appliance described above under the eighth version of the invention. In this embodiment, the method comprises the following steps. First, the keyboard diagram pattern of the bottom stamping surface of the stamping appliance is momentarily placed adjacent to the surface of a display medium on which is displayed a musical composition for playing the piano, organ or keyboard, wherein the musical composition is comprised of at least one staff that is displayed on the display medium, and wherein the keyboard diagram pattern on the bottom stamping surface is positioned above or below the at least one staff on the display medium. Second, the keyboard diagram pattern on the bottom stamping surface of the stamping appliance is removed from the surface of the display medium in a manner so that an ink facsimile of the raised keyboard diagram pattern is left on the display medium when the keyboard diagram pattern on the bottom stamping surface is removed from the display medium. In other embodiments of the ninth version of the invention, the method further comprises the step of placing the piano, organ or keyboard fingering for the portion of the musical composition corresponding to the position of the at least one staff where the facsimile keyboard diagram is positioned on the facsimile keyboard diagram.

There has thus been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the appended drawings, in which:

FIG. 1 is a plan view of an embodiment of a system comprising a first version of the invention, as viewed from above the system.

FIG. 2 is a plan view of embodiments of articles comprising a second and third version of the invention, as viewed from above the articles.

FIG. 3A is a perspective view of an embodiment of an article of a fourth version of the invention, as viewed from the side of and above the article.

FIG. 3B is a plan view of another embodiment of an article comprising the fourth version of the invention, as viewed from above the article.

FIG. 4A is a perspective view of an embodiment of a stamping appliance comprising a sixth version of the invention, as viewed from the side of and below a stamping member comprising the stamping appliance and from the side of and above an ink blotting pad member comprising the stamping appliance.

FIG. 4B is a perspective view of the embodiment of the stamping member illustrated in FIG. 4A, as viewed from the side of and above the stamping member, illustrating creation of a facsimile keyboard diagram on a display medium by means of the stamping appliance.

FIG. 5A is a perspective view of an embodiment of a stamping appliance comprising an eighth version of the invention, as viewed from the side of and below the stamping appliance.

FIG. 5B is a perspective view of the embodiment of the stamping appliance illustrated in FIG. 5A, as viewed from the side of and above the stamping appliance, illustrating creation of a facsimile keyboard diagram on a display medium by means of the stamping appliance.

### DETAILED DESCRIPTION

Reference will now be made in detail to the preferred aspects, versions and embodiments of the present invention, examples of which are illustrated in the accompanying drawings. While the invention will be described in conjunction with the preferred aspects, versions and embodiments, it is to be noted that the aspects, versions and embodiments are not intended to limit the invention to those aspects, versions and embodiments. On the contrary, the invention is intended to cover alternatives, modifications and equivalents, which may be included within the spirit and scope of the invention as defined by the appended claims.

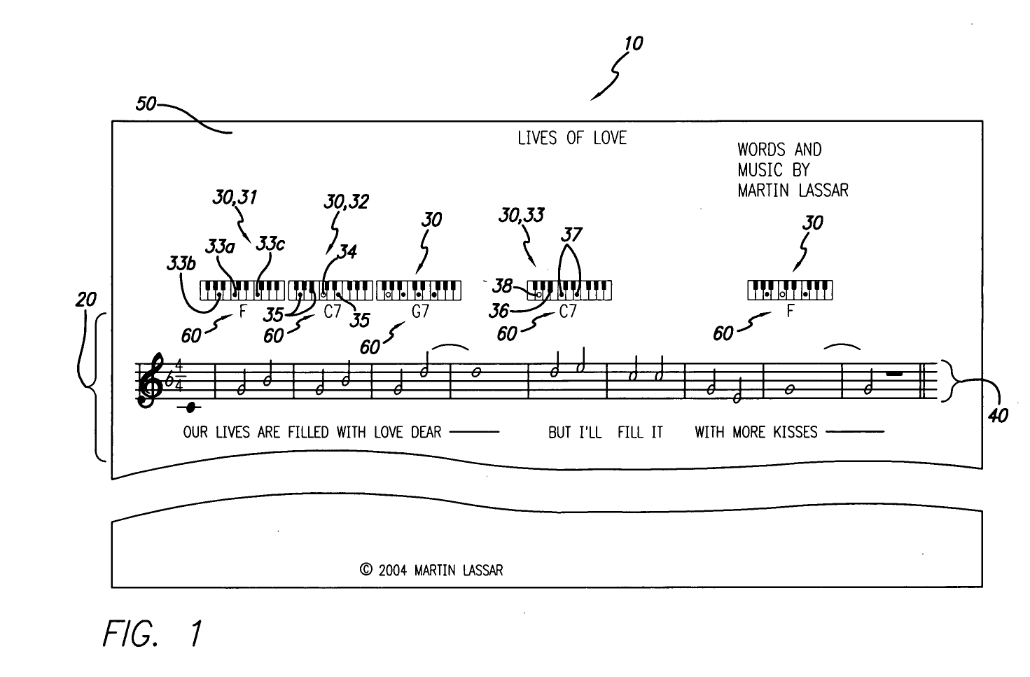

One embodiment of a first version of the present invention is illustrated in FIG. 1. This embodiment of the first version of the invention is a system 10 that comprises a musical composition 20 for playing the piano, organ or keyboard and a series of keyboard diagrams 30. In this embodiment, the musical composition 20 is comprised of at least one staff 40 that is displayed on a display medium 50. In this embodiment, the keyboard diagrams 30 are positioned on the display medium 50 above each staff 40. Each keyboard diagram 30 displays the piano, organ or keyboard fingering for the portion of the musical composition 20 corresponding to the position of the staff 40 where the keyboard diagram 30 is positioned. In other embodiments of this first version of the invention, the keyboard diagrams 30 may be positioned on the display medium 50 below each staff 40. Alternatively, some of the keyboard diagrams 30 may be positioned on the display medium 50 above a staff 40 and other keyboard diagrams 30 may be positioned on the display medium 50 below a staff 40. It is to be noted that in the various embodiments of the system 10 of this first version of the invention, the number of keyboard diagrams 30 is dependent upon the number of corresponding portions of the musical composition 20, as described in more detail below. In addition, in the embodiment of the first version of the invention illustrated in FIG. 1, the display medium 50 is a sheet of paper, such as is commonly used in “sheet music.” In other embodiments, the display medium 50 may be comprised of any material having a surface suitable for permanent recordation of musical compositions that currently exist in the art or that may be developed in the art in the future. Examples of such materials include woods, papers, metals, polymers, fabrics, or any combination of such materials. In other embodiments, the display medium 50 may be comprised of any type of electronic display that currently exists in the art or that may be developed in the art in the future. Examples of such electronic displays include cathode ray tubes, light emitting diodes, liquid crystal displays, or any combination thereof.

In the embodiment of the system 10 of the first version of the invention illustrated in FIG. 1, the musical composition 20 further comprises a series of chord designations 60 that are positioned on the display medium 50 above each staff 40. In other embodiments of this first version of the invention, the chord designations 60 may be positioned on the display medium 50 below each staff 40. Alternatively, some of the chord designations 60 may be positioned on the display medium 50 above a staff 40 and other chord designations 60 may be positioned on the display medium 50 below a staff 40. It is to be noted that in the various embodiments of the system 10 of this first version of the invention, the number of chord designations 60 is dependent upon the tastes of the composer of the musical composition 20. In the embodiment of the system 10 of the first version of the invention illustrated in FIG. 1, the portion of the musical composition 20 to which each keyboard diagram 30 corresponds is the chord designation 60 positioned on the display medium 50 below the keyboard diagram 30. In other embodiments, some of the chord designations 60 may not have a corresponding keyboard designation 30. In still other embodiments of this first version of the invention, the portion of the musical composition 20 to which each keyboard diagram 30 corresponds may be comprised of one or more of the musical notes depicted on each staff 40.

In the embodiment of the system 10 of the first version of the invention illustrated in FIG. 1, each keyboard diagram 30 is comprised of diagrams depicting 11 white keys and eight black keys in the form of a keyboard. Thus, in this embodiment, each keyboard diagram 30 consists of one and one-half octaves. Although this embodiment represents the most preferred format and number of keys, in other embodiments each keyboard diagram 30 may be comprised of diagrams depicting less than 11 white keys or less than eight black keys, or any combination thereof, in the form of a keyboard. Preferably, however, each keyboard diagram 30 is comprised of diagrams depicting at least seven white keys and at least five black keys, and no more than 11 white keys and no more than eight black keys, in the form of a keyboard. In the embodiment of the system 10 of the first version of the invention illustrated in FIG. 1, some of the piano, organ or keyboard fingering corresponding to the musical composition 20 is depicted on each keyboard diagram 30 in the form of circles. For example, the circles 33a, 33b, 33c on the keyboard diagram 31 indicate that the notes F, A and C are to be played on the piano, organ or keyboard, which correspond to the first chord designation 60 (an F chord) on the top staff 40 of the musical composition 20. In other embodiments, other marks or symbols may be used to designate the keys to be played. For example, the designated notes could be marked with a star, square, diamond, “x”, cross or any other indicia or combinations of all such indicia. In the embodiment of the system 10 of the first version of the invention illustrated in FIG. 1, some of the piano, organ or keyboard fingering corresponding to the musical composition 20 is depicted on each keyboard diagram 30 in the form of annuluses. For example, the annulus 34 on the keyboard diagram 32 indicates that the note C is to be played on the piano, organ or keyboard, and the circles 35 on the keyboard diagram 32 indicate that the notes G, Bb and E are to be played on the piano, organ or keyboard, which together correspond to the second chord designation 60 (a C⁷ chord) on the top staff 40 of the musical composition 20. In this embodiment, the annulus 34 on the keyboard diagram 32 indicates that the note represented by the annulus 34 is the same as a note depicted in the immediately prior keyboard diagram 31. For example, the note C of the C⁷ chord represented by the annulus 34 on keyboard diagram 32 is the same as the note C of the F chord represented by the circle 33a on keyboard diagram 31. Thus, in this embodiment, a player of the music can instantly see which fingers need to change position to play the next chord. It is to be noted that other marks or symbols other than an annulus may be used to indicate the same notes in other embodiments of the invention. For example, the repeated notes could be marked with a star, square, diamond, “x”, cross or any other indicia or combinations of all such indicia, as long as the indicia are consistently used and different from the indicia designating non-repeating notes. It is also to be noted, however, that in other embodiments of the invention, all marks or symbols on the keyboard diagrams 30 designating the fingering may be of the same shape, size or other characteristics. In yet other embodiments of the invention, all marks or symbols on the keyboard diagrams 30 designating the fingering may be of any combinations of shapes, sizes or other characteristics. In cases where the appropriate fingering involves sharps or flats, the appropriate fingering can be depicted by different orientation of the marks or symbols on the keyboard diagram. For example, in the embodiment of the first version of the invention illustrated in FIG. 1, the circle 36 of keyboard diagram 33 is placed immediately below the black key corresponding to the circle 36, indicating that that black key should be played as a part of the C⁷ chord corresponding to keyboard diagram 33. In contrast, the circles 37 and the annulus 38 of keyboard diagram 33 are placed at the bottom of the white keys corresponding to the circles 37 and annulus 38, respectively, indicating that these white keys should be played as a part of the C⁷ chord corresponding to the keyboard diagram 33. In other embodiments of this first version of the invention, any other suitable means may be used to denote whether black keys should be played, such as by placing the mark or symbol wholly or partially on the corresponding black key.

Thus, the piano, organ or keyboard player may observe the appropriate keyboard fingering directly above the music that is being played. There is no need to look away from the music to find the appropriate fingering. Similarly, there is no need to look through a grouping of keyboard diagrams to see which one corresponds to the desired music, and there is no need to turn the page. The player may therefore easily and conveniently determine the appropriate fingering without the need to stop the flow of the music. The system 10 consequently meets the needs described above in the Background section. In addition, in the embodiments where different marks are used, as illustrated and described above in connection with FIG. 1, the player may immediately see which fingers need to be repositioned to different keys, and which fingers need to be left on the same keys, to play the next portion of music. This makes playing even simpler and provides for even less pause in playing the music.

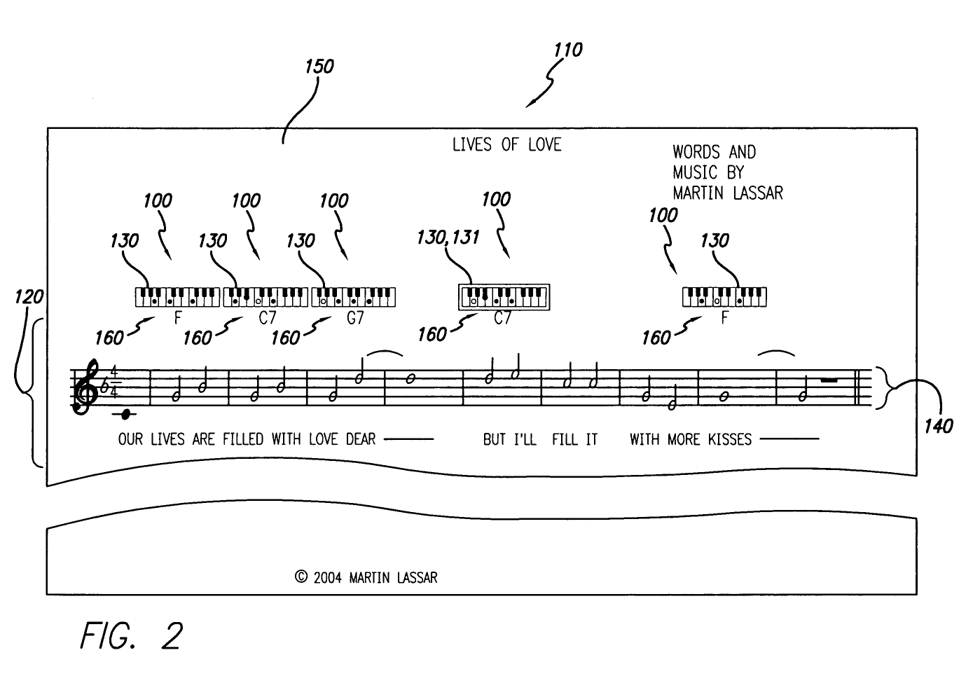

An embodiment of a second version of the present invention is illustrated in FIG. 2. This embodiment is an article 100 that provides musical notation for playing the piano, organ or keyboard. In this embodiment, the article 100 is comprised of a series of keyboard diagrams 130 and keyboard diagram attachment means, which are described in more detail below. In this embodiment, the keyboard diagrams 130 are attached by the keyboard diagram attachment means to a display medium 150 on which is displayed a musical composition 120 for playing the piano, organ or keyboard. Also in this embodiment, the musical composition 120 is comprised of at least one staff 140 that is displayed on the display medium 150. The keyboard diagrams 130 are positioned on the display medium 150 above or below each staff 140. Further, in the embodiment of this second version of the invention illustrated in FIG. 2, each keyboard diagram 130 attached to the display medium 150 displays the piano, organ or keyboard fingering for the portion of the musical composition 120 corresponding to the position of the staff 140 where the keyboard diagram 130 is positioned. It is to be noted that in some embodiments of this second version of the invention, the piano, organ or keyboard fingering may be a part of each keyboard diagram 130. For example, the appropriate fingering may be depicted on the white key and black key diagrams comprising the keyboard diagram 130 in the manner described in more detail above in connection with the embodiments of the first version of the invention illustrated in FIG. 1. In other embodiments, the chord designation 160 corresponding to a particular chord may also be displayed on the keyboard diagram 130. For example, a keyboard diagram 130 having the fingering for the C chord displayed thereon may also have the chord designation “C” displayed on the keyboard diagram 130. In yet other embodiments, the piano, organ or keyboard fingering may not be a part of each keyboard diagram 130. In these embodiments, the piano, organ or keyboard fingering may be added later, as by marking the fingering on the keyboard diagram 130 with ink or other marking means, as discussed in more detail below. In either case, it is the intent that each keyboard diagram 130, when attached to the display medium 150 by using the keyboard diagram attachment means described in more detail below, corresponds to at least one note on a staff 140 or chord designation 160 of the musical composition 120 in the same manner as described above in connection with the embodiments of the first version of the invention illustrated in FIG. 1. Thus, the second version of the invention provides a means for the player to add keyboard diagrams 130 to an existing musical composition 120 on a display medium 150 that did not originally have keyboard diagrams. In the same manner as described above in connection with the embodiment of the first version of the invention illustrated in FIG. 1, the keyboard diagrams 130 of this embodiment of the second version of the invention may be placed above or below, or any combination of above or below, each staff 140.

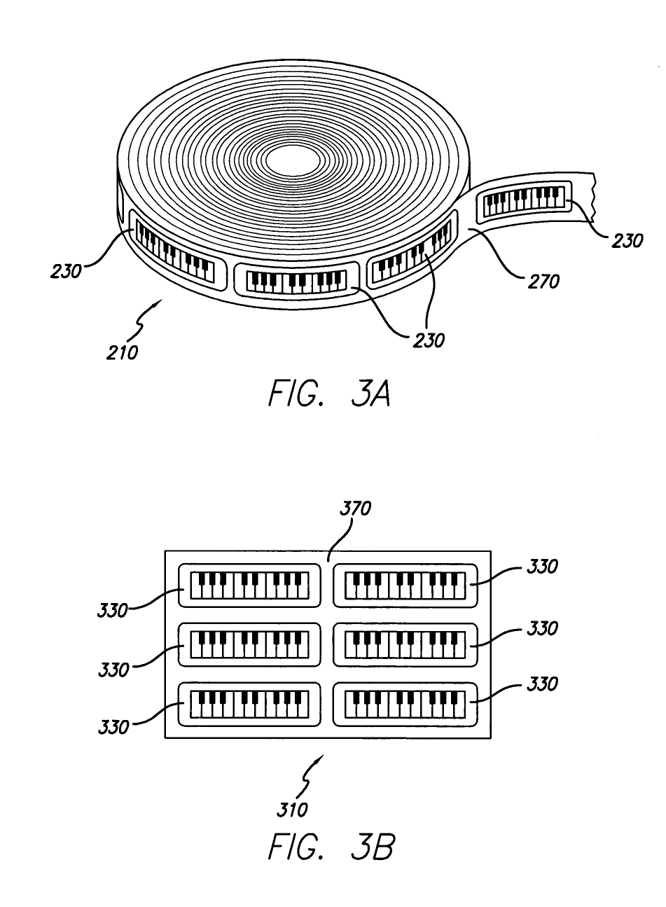

In some embodiments of the second version of the invention, as illustrated in FIG. 2, the keyboard diagrams 130 are of substantially the same size and shape as the white key and black key diagrams comprising the keyboard diagrams 130. In other embodiments, each keyboard diagram may be of almost any size and shape, including a size and shape different from the white key and black key diagrams comprising the keyboard diagram, as long as the keyboard diagram fits within the available space above or below, as appropriate, the musical composition 120. For example, the keyboard diagram 131 is larger than the white key and black key diagrams comprising the keyboard diagram 131, but generally has the same rectangular shape. In other embodiments, as illustrated in FIG. 3A, the keyboard diagrams 230 may also be of a slightly different shape, such as the generally rectangular keyboard diagrams 230 having rounded corners. Returning to FIG. 2, the preferred size and shape of the keyboard diagrams 130 is dependent upon the individual taste of the player, the size of the musical composition 120, and the space between the staffs 140. The more preferred size and shape of the keyboard diagrams 130 is the same as the white key and black key diagrams comprising the keyboard diagrams 130. It is to be noted that the background of the keyboard diagrams 130 may be of almost any color, may be shades of the same color, may be transparent, or may be any combination of the same. The preferred color of the background of the keyboard diagrams 130 is dependent upon the individual taste of the player and the color of the display medium 150. More preferably, the background of the keyboard diagrams 130 is the same color as the display medium or transparent. In the embodiment of the second version of the invention illustrated in FIG. 2, the keyboard diagrams 130 may be constructed of almost any suitable material currently known in the art or developed in the art in the future. For example, the keyboard diagrams 130 may be comprised of papers, metal foils, polymers, plastics, wood, cloth, fabric, synthetic materials, natural materials, or any combination of all such materials. Although the preferred material for constructing the keyboard diagrams 130 is dependent upon the individual taste of the player and the material comprising the display medium 150, it is also preferred that the keyboard diagrams 130 be comprised of paper or a flexible polymer material, such as polyester (such as MYLAR sold by Dupont Teijin Films), vinyl (such as FLEXMARK PLV-400-FW sold by FLEXcon), polyimide, polyethylene napthalate (such as TEDLER sold by ICI), polycarbonates (such as LEXAN sold by General Electric), polyester-polycarbonate blends, or a similar polymer or combinations of such polymers. More preferably, in such cases, the keyboard diagrams 130 are comprised of a polyester film or a vinyl polymer film.

In the embodiment of this second version of the invention illustrated in FIG. 2, the keyboard diagram attachment means is dependent upon the individual tastes of the player and the materials comprising the keyboard diagram 130 and the display medium 150, and may be almost any means currently known in the art or developed in the art in the future that are suitable to attach the keyboard diagram 130 to the display medium 150. For example, in some embodiments, the keyboard diagram attachment means may provide for removable attachment of the keyboard diagram 130 to the display medium 150, such as by static electrification where the keyboard diagram 130 and the display medium 150 are comprised of materials that allow for such electrification (e.g., a keyboard diagram 130 constructed of flexible polyester film and a display medium 150 constructed of a smooth plastic material). In these embodiments, a student player may place keyboard diagrams 130 on the display medium 150 while learning the music, and then remove them once the music has been mastered. In other embodiments, the keyboard diagram attachment means may provide for permanent attachment of the keyboard diagram 130 to the display medium 150. Examples of such means include glues, adhesives, epoxies, pastes, adhesive tapes, stitching, or any combination of such means. The preferred keyboard diagram attachment means is an adhesive layer applied to the bottom surface of the keyboard diagram 130, where the adhesive layer is overlaid by backing material (such as paper) that can be peeled away from the adhesive layer on the bottom surface of the keyboard diagram 130, as described below in more detail in connection with a third version of the present invention. An example of this means is the acrylic pressure-sensitive adhesive sold by FLEXcon under the trade name V-29 backed with a poly-coated layflat release liner sold by FLEXcon under the trade name 90 PFW, or similar adhesive and backing materials.

One embodiment of a third version of the present invention is also an article 110, as illustrated in FIG. 2, that provides musical notation for playing the piano, organ or keyboard. In this embodiment of the third version of the invention, the article 110 is comprised of a musical composition 120 for playing the piano, organ or keyboard, such musical composition 120 being displayed on a display medium 150, at least one keyboard diagram 130, and keyboard diagram attachment means, which are described in more detail below. In this embodiment, the at least one keyboard diagram 130 and the keyboard diagram attachment means have substantially the same features and characteristics as the keyboard diagrams 130 and the keyboard diagram attachment means, respectively, described above in connection with the embodiment of the second version of the invention illustrated in FIG. 2. Also in this embodiment of the third version of the invention, the at least one keyboard diagram 130 is attached by the keyboard diagram attachment means to the display medium 150 on which is displayed the musical composition 120, which is comprised of a series of staffs 140 that are displayed on the display medium 150. Further, in this embodiment, the at least one keyboard diagram 130 is positioned on the display medium 150 above or below, or in any combination of above and below, each of the staffs 140. Further, in the embodiment of this second version of the invention illustrated in FIG. 2, each keyboard diagram 130 displays the piano, organ or keyboard fingering for the portion of the musical composition 120 corresponding to the position of the staff 140 where the keyboard diagram 130 is positioned. It is to be noted that in some embodiments of this third version of the invention, the piano, organ or keyboard fingering may be a part (or may not be a part) of each keyboard diagram 130 in the same manner as in the embodiment of the second version of the invention illustrated and described above in connection with FIG. 2. Thus, the article 110 of the embodiments of this third version of the invention includes the articles 100, the display medium 150, and the musical composition 120 of the embodiments of the second version of the invention described above and illustrated in connection with FIG. 2.

One embodiment of a fourth version of the present invention is illustrated in FIG. 3A. This embodiment is also comprised of an article 210 that provides musical notation for playing the piano, organ or keyboard. In this embodiment, the article 210 comprises at least one keyboard diagram 230, keyboard diagram attachment means, which are described in more detail below, a support member 270, and support attachment means, which are described in more detail below. In this embodiment, the at least one keyboard diagram 230 may have substantially the same features as the keyboard diagrams 130 of the embodiment of the second version of the invention illustrated in and described above in connection with FIG. 2. Also in this embodiment, the keyboard diagram attachment means may be substantially the same as the keyboard diagram attachment means of the embodiment of the second version of the invention illustrated in and described above in connection with FIG. 2. In the embodiment of the second version of the invention illustrated in FIG. 3A, the at least one keyboard diagram 230 is removably attached to the support member 270 by using the support attachment means described in more detail below. Thus, in this embodiment, the support attachment means allows the at least one keyboard diagram 230 to be removably attached to the support member 270 until such time as the player desires to remove the at least one keyboard diagram 230 from the support member 270 and attach it to the display medium 150 in the manner illustrated in and described above in connection with FIG. 2.

It is preferred that the support attachment means and the keyboard diagram attachment means be the same, where such means allow the keyboard diagram 230 to be removably attached to the support member 270 and the keyboard diagram 230 to be removably or permanently attached to the display medium 150 in the manner illustrated in and described above in connection with FIG. 2. For example, the support attachment means and the keyboard diagram attachment means may both be static electrification where the keyboard diagram 230 is comprised of a flexible polyester film, the support member 270 is comprised of a poly-coated layflat release liner, and the display medium 150 is constructed of a smooth plastic material. As another example, the support attachment means and the keyboard diagram attachment means may both be a pressure-sensitive adhesive layer applied to the bottom surface of the keyboard diagram 230, wherein the keyboard diagram 230 is comprised of a flexible polyester film, the support member 270 is comprised of a poly-coated layflat release liner, and the display medium 150 is constructed of paper. An example of this type of means is the acrylic pressure-sensitive adhesive sold by FLEXcon under the trade name V-29 backed with a poly-coated layflat release liner sold by FLEXcon under the trade name 90 PFW, or similar adhesive and backing materials. Using this means, the support member 270 may be peeled away from the keyboard diagram 230 and the keyboard diagram 230 may then be permanently attached to the display medium 150 in the manner illustrated in and described above in connection with FIG. 2.

In the embodiment of this fourth version of the invention illustrated in FIG. 3A, the support member 270 is of a size adapted so that more than one keyboard diagram 230 may be removably attached to the support member 270 using the support attachment means. Further, in this embodiment, the support member 270 is comprised of a flexible or semi-flexible material that is elongated so that at least two keyboard diagrams 230 may be removably attached to the support member 270 along its longitudinal axis. In this embodiment, the support member 270 is rolled up in the form of a roll. Alternatively, the elongated support member 270 may be folded. In this embodiment, when a player desires to use a keyboard diagram 230, the support member 270 is unrolled (or unfolded), the keyboard diagram 230 is peeled away from the support member 270, and the keyboard diagram 230 may then be attached to the display medium 150 in the manner illustrated in and described above in connection with FIG. 2. It is to be noted that in other embodiments of this fourth version of the invention, the support member 270 may be of almost any size and shape, as long as it is the same size or larger than the at least one keyboard diagram 230. For example, the support member 270 of this embodiment may be wider and have two or more keyboard diagrams 230 placed side-by-side on the support member 270. As another example, in the embodiment of this fourth version of the invention illustrated in FIG. 3B, the support member 370 comprising the article 310 is in the form of a sheet to which are removably attached six keyboard diagrams 330. In this embodiment, the support member 370 may be comprised of a flexible, semi-rigid, or rigid material. Although the support member 370 of the embodiment illustrated in FIG. 3B is rectangular in shape, the support member of other embodiments may be of different shapes, such as a square, circle, ellipsoid, trapezoid, curve, or any other shape or combination of all such shapes. In addition, the support member 370 may be of almost any size and have any number of keyboard diagrams 330 removably attached thereto. The preferred size and shape of the support member 270, 370 in this fourth version of the invention is dependent upon the individual tastes of the player. Thus, the embodiments of this fourth version of the invention provide an even more convenient means for the player to add the type of keyboard diagrams 130 described above in connection with the embodiments of the second version of the invention illustrated in FIG. 2 to an existing musical composition that does not have them.

One embodiment of a fifth version of the invention is a method of using various embodiments of the article 210, 310 of the fourth version of the invention, as illustrated in and described above in connection with FIG. 3A and FIG. 3B. In this embodiment, the method is comprised of the steps of removing at least one keyboard diagram 230, 330 from the support member 270, 370, and attaching the at least one keyboard diagram 230, 330 to the display medium 150 using the keyboard diagram attachment means in the manner illustrated in and described above in connection with FIG. 2, so that the at least one keyboard diagram 230, 330 is positioned on the display medium 150 above or below a staff 140. In other embodiments of this fourth version of the invention, the method further comprises the step of displaying on the at least one keyboard diagram 230, 330 the piano, organ or keyboard fingering for the portion of the musical composition 120 corresponding to the position of the at least one staff 140 where the keyboard diagram 230, 330 is positioned. Such display of the piano, organ or keyboard fingering may be a part of the keyboard diagram 230, 330 in some embodiments. In other embodiments, the display of the piano, organ or keyboard fingering may be made by the player or another person on the keyboard diagram 230, 330 using any suitable means, such as by typing, printing (such as with a computer printer), writing (such as with pen and ink), or any other means or combination of all such means.

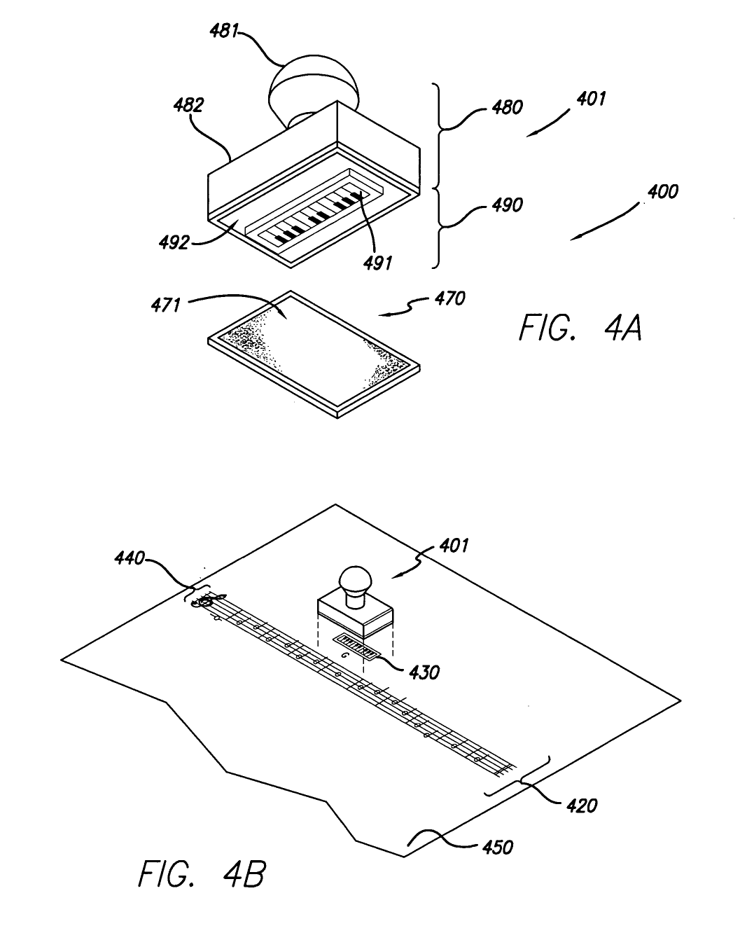

One embodiment of a sixth version of the present invention is illustrated in FIG. 4A. In this embodiment, a stamping appliance 400 provides musical notation for playing the piano, organ or keyboard. In this embodiment, the stamping appliance 400 comprises a stamping member 401 and an ink blotting pad member 470 having a blotting surface 471 that is saturated with ink. In other embodiments, the stamping appliance 400 may be comprised of only the stamping member 401. In the embodiment illustrated in FIG. 4A, the stamping member 401 is further comprised of a handle portion 480 and a stamping portion 490 having a raised keyboard diagram pattern 491 on the bottom stamping surface 492 thereof. Also in this embodiment, the bottom stamping surface 492 of the stamping portion 490 is placed adjacent to the blotting surface 471 of the ink blotting pad member 470 so that the raised keyboard diagram pattern 491 on the bottom stamping surface 492 is coated with a layer of ink. The stamping portion 490 of the stamping member 401 is then removed from the blotting surface 471 of the ink blotting pad member 470. In this embodiment, as illustrated in FIG. 4B, the raised keyboard diagram pattern 491 of the bottom stamping surface 492 is then momentarily placed adjacent to the surface of a display medium 450 in a manner so that an ink facsimile keyboard diagram 430 of the raised keyboard diagram pattern 491 is left on the display medium 450 when the raised keyboard diagram pattern 491 of the bottom stamping surface 492 of the stamping member 401 is removed from the display medium 450. Also in this embodiment, as illustrated in FIG. 4B, the keyboard diagram 430 is positioned on the display medium 450 above or below, or any combination of above and below, at least one staff 440 that comprises a musical composition 420 for playing the piano, organ or keyboard that is displayed on the display medium 450. The ink facsimile keyboard diagram 430 remaining on the display medium 450, as well as the display medium 450 and the musical composition 420 displayed on the display medium 450, in this embodiment may have substantially the same features as the keyboard diagram 30, the display medium 50, and the musical composition 20, respectively, of the first version of the invention illustrated and discussed above in connection with FIG. 1. It is to be noted that in some embodiments of this sixth version of the invention, the piano, organ or keyboard fingering may be a part (or may not be a part) of each such facsimile keyboard diagram 430 in the same manner as for the keyboard diagrams 30 in the embodiments of the first version of the invention illustrated and described above in connection with FIG. 1. As a result, the raised keyboard diagram pattern 491 of this embodiment of the sixth version of the invention may also have substantially all of the same features and characteristics as the keyboard diagrams 30 in the embodiments of the first version of the invention illustrated and described above in connection with FIG. 1, except that the raised keyboard diagram pattern 491 is the mirror image of the keyboard diagrams 30.

In the embodiment of this sixth version of the invention illustrated in FIG. 4A, the handle portion 480 of the stamping member 401 is comprised of a knob-shaped portion 481 and a rectangular or block-shaped portion 482. In other embodiments of this sixth version of the invention, the handle portion 480 of the stamping member 401 may be of almost any shape, such as in the case where all of the handle portion 480 is approximately rectangular or block-shaped. In various embodiments of this sixth version of the invention, the handle portion 480 of the stamping member 401 may be constructed of almost any suitable material currently known in the art or developed in the art in the future. For example, the handle portion 480 may be constructed of woods, metals, ceramics, polymers, plastics, rigid and semi-rigid synthetic and natural materials, and any combination of such materials. In addition, the stamping portion 490 of the stamping member 401 may also be of almost any shape in various embodiments of this sixth version of the invention, as long as the bottom stamping surface 492 is flat so that it does not interfere with the impression of the facsimile keyboard diagram 430 made by the raised keyboard diagram pattern 491 on the display medium 450. The stamping portion 490 of the stamping member 401 may also be constructed of almost any suitable material currently known in the art or developed in the art in the future. For example, the stamping portion 490 may be constructed of rubber, polymers, plastics, fabrics, synthetic and natural materials, and any combination of such materials. Thus, almost any type of conventional stamp, such as stamps commonly known as “rubber stamps,” may be used as the handle portion 480 and the stamping portion 490 of the stamping member 401 in this sixth version of the invention, as long as the bottom stamping surface 492 has the raised keyboard diagram pattern 491 thereon. In addition, the ink blotting pad member 470 may be any suitable ink pad commonly used in connection with such stamps. The ink used to saturate the ink blotting pad member 470 may be any suitable liquid capable of leaving a removable or indelible optically observable facsimile keyboard diagram 430 on the display medium 450.

One embodiment of a seventh version of the present invention is a method of using the embodiment of the stamping appliance 400 of the sixth version of the invention illustrated in and described above in connection with FIG. 4A and FIG. 4B. In this embodiment, the method comprises the following steps. First, the bottom stamping surface 492 of the stamping portion 490 of the stamping member 401 is placed adjacent to a blotting surface 471 of the ink blotting pad member 470 in a manner so that the raised keyboard diagram pattern 491 on the bottom stamping surface 492 is coated with a layer of ink. Second, the bottom stamping surface 492 of the stamping portion 490 is removed from the ink blotting pad member 470. Third, the raised keyboard diagram pattern 491 of the bottom stamping surface 492 of the stamping member 401 is momentarily placed adjacent to the surface of a display medium 450 on which is displayed a musical composition 420 for playing the piano, organ or keyboard, wherein the musical composition 420 is comprised of at least one staff 440 that is displayed on the display medium 450, and wherein the raised keyboard diagram pattern 491 is positioned above or below the at least one staff 440 on the display medium 450. Fourth, the raised keyboard diagram pattern 491 on the bottom stamping surface 492 of the stamping member 401 is removed from the surface of the display medium 450 in a manner so that a facsimile keyboard diagram 430 of the raised keyboard diagram pattern 491 is left on the display medium 450 when the raised keyboard diagram pattern 491 of the bottom stamping surface 492 is removed from the display medium 450. In other embodiments of the seventh version of the invention, the method further comprises the step of placing on the facsimile keyboard diagram 430 the piano, organ or keyboard fingering for the portion of the musical composition 420 corresponding to the position of the at least one staff 440 where the facsimile keyboard diagram 430 is positioned. Such display of the piano, organ or keyboard fingering may be a part of the raised keyboard diagram pattern 491 (and therefore also a part of the resulting facsimile keyboard diagram 430) in some embodiments. In other embodiments, the display of the piano, organ or keyboard fingering may be made by the player or another person on the facsimile keyboard diagram 430 by using any suitable means, such as by typing, printing (such as with a computer printer), writing (such as with pen and ink), or any other means or combination of all such means.

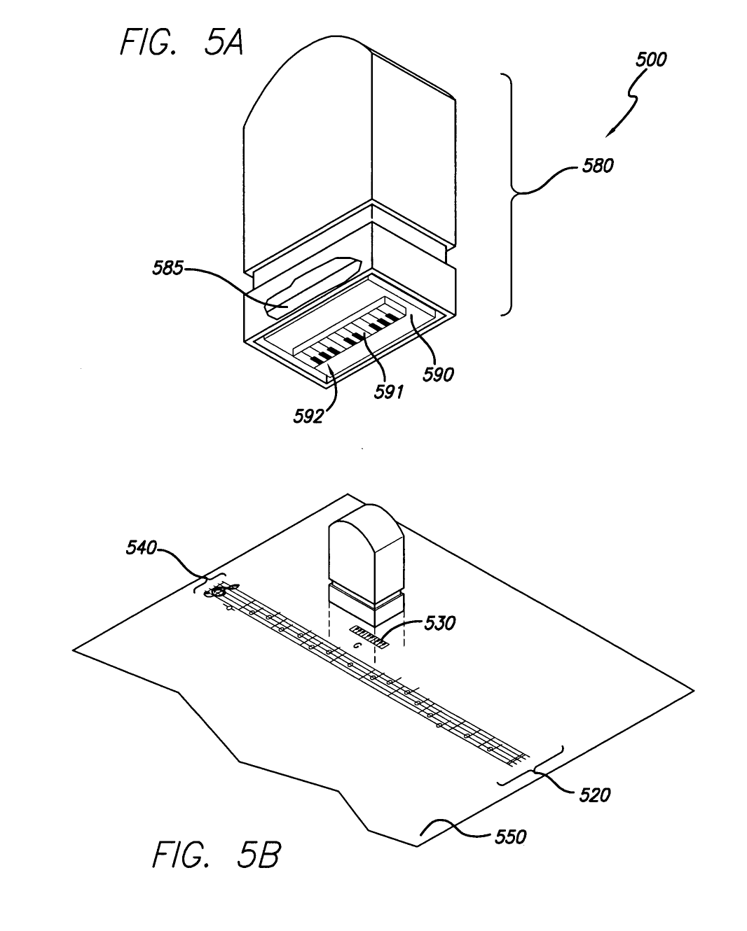

An embodiment of an eighth version of the present invention is illustrated in FIG. 5A. In this embodiment, a stamping appliance 500 also provides musical notation for playing the piano, organ or keyboard. In this embodiment, the stamping appliance 500 comprises a handle portion 580 having an ink source 585 and a stamping portion 590 having a raised keyboard diagram pattern 591 on the bottom stamping surface thereof 592. Also in this embodiment, the stamping portion 590 is positioned approximately at one end of the handle portion 580 adjacent to a surface of the ink source 585, so that a layer of ink coats the raised keyboard diagram pattern 591 on the bottom stamping surface 592 as a result of the bottom stamping portion 590 being in physical contact with the ink source 585. In this embodiment, as illustrated in FIG. SB, the raised keyboard diagram pattern 591 of the bottom stamping surface 592 is momentarily placed adjacent to the surface of a display medium 550 in a manner so that an ink facsimile keyboard diagram 530 of the raised keyboard diagram pattern 591 is left on the display medium 550 when the raised keyboard diagram pattern 591 of the bottom stamping surface 592 of the stamping appliance 500 is removed from the display medium 550. Also in this embodiment, as illustrated in FIG. 5B, the facsimile keyboard diagram 530 is positioned on the display medium 550 above or below, or any combination of above and below, at least one staff 540 that comprises a musical composition 520 for playing the piano, organ or keyboard that is displayed on the display medium 550. The ink facsimile keyboard diagram 530 remaining on the display medium 550, as well as the display medium 550 and the musical composition 520 displayed on the display medium 550, in this embodiment may have substantially the same features as the keyboard diagram 30, the display medium 50, and the musical composition 20, respectively, of the first version of the invention illustrated and discussed above in connection with FIG. 1. It is to be noted that in some embodiments of this eighth version of the invention, the piano, organ or keyboard fingering may be a part (or may not be a part) of each such facsimile keyboard diagram 530 in the same manner as for the keyboard diagrams 30 in the embodiments of the first version of the invention illustrated and described above in connection with FIG. 1. As a result, the raised keyboard diagram pattern 591 of this embodiment of the eighth version of the invention may also have substantially all of the same features and characteristics as the keyboard diagrams 30 in the embodiments of the first version of the invention illustrated and described above in connection with FIG. 1, except that the raised keyboard diagram pattern 591 is the mirror image of the keyboard diagrams 30.

In the embodiment of this eighth version of the invention illustrated in FIG. 5A, the handle portion 580 of the stamping appliance 500 is further comprised of a mechanism that presses a surface of the stamping portion 590 against the ink source 585 in a manner so that the raised keyboard diagram pattern 591 is coated with a layer of ink. In some embodiments of this eighth version of the invention, the bottom stamping surface 592 of the stamping portion 590 may be placed against the ink source 585 by such mechanism. In other embodiments, the surface of the stamping portion 590 opposite the bottom stamping portion 592 may be placed against the ink source 585. In the latter embodiments, all or a portion of the stamping portion 590 may be constructed of an ink permeable material. Such mechanism also causes the raised keyboard diagram pattern 591 on the bottom stamping surface 592 of the stamping portion 590 to be pressed against the surface of the display medium 550 when the user of the stamping appliance 500 applies pressure against the handle portion 580. Any suitable handle and mechanism means currently known in the art or that may be developed in the art in the future may be utilized as the handle portion 580 of the stamping appliance 500 in various embodiments of this eighth version of the invention. Examples of such handle and mechanism means are described in more detail in U.S. Pat. Nos. 5,826,506, 5,377,599, and 4,841,860, the disclosures of which are hereby incorporated by reference. In addition, the stamping portion 590 of the stamping appliance 500 may also be of almost any shape in various embodiments of this eighth version of the invention, as long as the bottom stamping surface 592 is flat so that it does not interfere with the impression of the facsimile keyboard diagram 530 made by the raised keyboard diagram pattern 591 on the display medium 550. The stamping portion 590 of the stamping appliance 500 may also be constructed of almost any suitable material currently known in the art or developed in the art in the future. For example, the stamping portion 590 may be constructed of rubber, polymers, plastics, fabrics, cloth, synthetic and natural materials, and any combination of such materials. In yet other embodiments of this eighth version of the invention, the stamping portion 590 may be comprised of ink permeable and ink impermeable portions on the bottom stamping surface 592, rather than the raised keyboard diagram pattern 591. In these embodiments, the ink permeable portion is in the shape of a keyboard diagram pattern so that when the bottom stamping surface 592 of the stamping appliance 500 is momentarily placed adjacent to the surface of the display medium 550, an ink facsimile keyboard diagram 530 having the shape of the keyboard diagram pattern on the permeable ink portion of bottom stamping surface 592 is left on the display medium 550. An example of this type of bottom stamping surface is described in more detail in U.S. Pat. No. 5,771,806, the disclosure of which is hereby incorporated by reference. Thus, almost any type of conventional stamp having an internal ink source, such as stamps commonly known as “pre-inked stamps” or “self-inking stamps,” may be used as the handle portion 580 and the stamping portion 590 of the stamping appliance 500 in this eighth version of the invention, as long as the bottom stamping surface 592 has the raised keyboard diagram pattern 591 or an ink permeable keyboard diagram pattern thereon. The ink used with the ink source 585 may be any suitable liquid capable of leaving a removable or indelible optically observable facsimile keyboard diagram 530 on the display medium 550.

One embodiment of a ninth version of the present invention is a method of using the embodiment of the stamping appliance 500 of the eighth version of the invention illustrated in and described above in connection with FIG. 5A and FIG. 5B. In this embodiment, the method comprises the following steps. First, a surface of the stamping portion 590 of the stamping appliance 500 is placed adjacent to a surface of the ink source portion 585 of the handle portion 580 in a manner so that the raised keyboard diagram pattern 591 on the bottom stamping surface 592 is coated with a layer of ink. Second, the raised keyboard diagram pattern 591 of the bottom stamping surface 592 of the stamping appliance 500 is momentarily placed adjacent to the surface of a display medium 550 on which is displayed a musical composition 520 for playing the piano, organ or keyboard, wherein the musical composition 520 is comprised of at least one staff 540 that is displayed on the display medium 550, and wherein the raised keyboard diagram pattern 591 is positioned above or below the at least one staff 540 on the display medium 550. Fourth, the raised keyboard diagram pattern 591 of the bottom stamping surface 592 of the stamping appliance 500 is removed from the surface of the display medium 550 in a manner so that a facsimile keyboard diagram 530 of the raised keyboard diagram pattern 591 is left on the display medium 550 when the raised keyboard diagram pattern 591 of the bottom stamping surface 592 is removed from the display medium 550. In other embodiments of the ninth version of the invention, the method further comprises the step of placing on the facsimile keyboard diagram 530 the piano, organ or keyboard fingering for the portion of the musical composition 520 corresponding to the position of the at least one staff 540 where the facsimile keyboard diagram 530 is positioned. Such display of the piano, organ or keyboard fingering may be a part of the raised keyboard diagram pattern 591 (and therefore also a part of the resulting facsimile keyboard diagram 530) in some embodiments. In other embodiments, the display of the piano, organ or keyboard fingering may be made by the player or another person on the facsimile keyboard diagram 530 by using any suitable means, such as by typing, printing (such as with a computer printer), writing (such as with pen and ink), or any other means or combination of all such means.

What is claimed is:

1. A system of musical notation for playing the piano, organ or keyboard, the system comprising:
(a) a musical composition for playing the piano, organ or keyboard, wherein the musical composition is comprised of at least one staff that is displayed on a display medium; and
(b) at least one keyboard diagram positioned on the display medium above or below each at least one staff;
(c) wherein the at least one keyboard diagram displays the piano, organ or keyboard fingering for the portion of the musical composition corresponding to the position of the at least one staff where the at least one keyboard is positioned.

2. The system of musical notation of claim 1, wherein the portion of the musical composition to which the at least one keyboard diagram corresponds is comprised of at least one musical note depicted on the at least one staff.

3. The system of musical notation of claim 1, wherein the display medium is comprised of an electronic display.

4. The system of musical notation of claim 3, wherein the electronic display is comprised of the group consisting of cathode ray tubes, light emitting diodes, liquid crystal displays, or any combination thereof.

5. The system of musical notation of claim 1, wherein the display medium is comprised of a material having a surface suitable for permanent recordation of musical compositions.

6. The system of musical notation of claim 5, wherein the display medium is comprised of the group consisting of woods, papers, metals, polymers, fabrics, or any combination of such materials.

7. The system of musical notation of claim 1, wherein the musical composition further comprises at least one chord designation that is positioned on the display medium above or below each at least one staff or positioned on the display medium in any combination of above and below each at least one staff.

8. The system of musical notation of claim 7, wherein the portion of the musical composition to which the at least one keyboard diagram corresponds is comprised of the at least one chord designation.

9. The system of musical notation of claim 1, wherein the at least one keyboard diagram is comprised of diagrams depicting at least seven white keys and at least five black keys in the form of a keyboard.

10. The system of musical notation of claim 9, wherein the at least one keyboard diagram is comprised of diagrams depicting not more than 11 white keys and not more than eight black keys in the form of a keyboard.

11. The system of musical notation of claim 10, wherein the at least one keyboard diagram is comprised of diagrams depicting 11 white keys and eight black keys in the form of a keyboard.

12. The system of musical notation of claim 1, wherein the piano, organ or keyboard fingering corresponding to the portion of the musical composition is depicted on the keyboard diagram in the form of at least one mark on at least one of the keys on the at least one keyboard diagram.

13. The system of musical notation of claim 12, wherein:
(a) there are at least two keyboard diagrams, wherein the first keyboard diagram corresponds to an earlier movement of the musical composition than the second keyboard diagram; and
(b) the at least one mark depicted on the second keyboard diagram has a different appearance from other marks on the second keyboard diagram if the fingering corresponding to such at least one mark is the same as in the immediately preceding first keyboard diagram.

14. The system of musical notation of claim 13, wherein:
(a) each at least one mark depicted on the second keyboard diagram that has the same piano, organ or keyboard fingering as in the immediately preceding first keyboard diagram is in the form of an annulus; and
(b) each other at least one mark is in the form of a circle.

15. An article that provides musical notation for playing the piano, organ or keyboard, the article comprising:
(a) a keyboard diagram; and
(b) keyboard diagram attachment means;
(c) wherein:
(i) the keyboard diagram is attached by the keyboard diagram attachment means to a display medium on which is displayed a musical composition for playing the piano, organ or keyboard, wherein the musical composition is comprised of at least one staff that is displayed on the display medium; and
(ii) the keyboard diagram is positioned on the display medium above or below, or any combination of above and below, the at least one staff.

16. The article of claim 15, wherein the keyboard diagram attachment means is comprised of the group consisting of glue, adhesive, static electrification, paste, epoxy, adhesive tape, stitching, or any combination of such means.

17. The article of claim 15, wherein the keyboard diagram is comprised of the group consisting of paper, polymers, plastics, metal foils, wood, cloth, fabric, synthetic materials, natural materials, or any combination of such materials.

18. The article of claim 15, wherein the keyboard diagram further comprises the piano, organ or keyboard fingering for the portion of the musical composition corresponding to the position of the at least one staff where the keyboard is positioned.

19. The article of claim 18, wherein the keyboard diagram further comprises the chord designation for the piano, organ or keyboard fingering for the portion of the musical composition corresponding to the position of the at least one staff where the keyboard is positioned.

20. An article that provides musical notation for playing the piano, organ or keyboard, the article comprising:
(a) at least one keyboard diagram;
(b) keyboard diagram attachment means, wherein:
(i) the at least one keyboard diagram is attached by the keyboard diagram attachment means to a display medium on which is displayed a musical composition for playing the piano, organ or keyboard, wherein the musical composition is comprised of at least one staff that is displayed on the display medium; and
(ii) the at least one keyboard diagram is positioned on the display medium above or below, or any combination of above and below, the at least one staff;
(c) a support member; and
(d) support attachment means, wherein the at least one keyboard diagram is removably attached to the support member using the support attachment means.

21. The article of claim 20, wherein the at least one keyboard diagram is comprised of the group consisting of papers, polymers, plastics, fabrics, metal foils, woods, cloth, fabrics, synthetic materials, natural materials, or any combination of such materials.

22. The article of claim 21, wherein:
(a) the keyboard diagram attachment means is comprised of an adhesive;
(b) the support attachment means is comprised of the adhesive; and
(c) the support member is comprised of a material that may be removably attached to the adhesive.

23. The article of claim 22, wherein the adhesive is a pressure-sensitive adhesive applied to the bottom surface of the at least one keyboard diagram and the support member is comprised of a poly-coated layflat release liner that may be peeled away from the adhesive.

24. The article of claim 20, wherein the support member is of a size adapted so that at least two keyboard diagrams may be removably attached to the support member using the support attachment means.

25. The article of claim 20, wherein:
(a) the support member is comprised of an elongated flexible or semi-flexible material;
(b) at least two keyboard diagrams are removably attached to the support member along the longitudinal axis of the support member; and
(c) the support member is rolled up in the form of a roll.

26. The article of claim 20, wherein the keyboard diagram displays the piano, organ or keyboard fingering for the portion of the musical composition corresponding to the position of the at least one staff where the keyboard is positioned.

27. A method of using the article of claim 26, such method comprising the steps of:
(a) first removing at least one keyboard diagram from the support member; and
(b) attaching the at least one keyboard diagram to the display medium using the keyboard diagram attachment means;
(c) wherein:
(i) the at least one keyboard diagram is positioned on the display medium above or below, or any combination of above and below, the at least one staff; and
(ii) the piano, organ or keyboard fingering for the portion of the musical composition corresponding to the position of the at least one staff where the keyboard is positioned is displayed on the at least one keyboard diagram.

28. A method of using the article of claim 20, such method comprising the steps of:
(a) first removing at least one keyboard diagram from the support member; and
(b) attaching the at least one keyboard diagram to the display medium using the keyboard diagram attachment means;
(c) wherein the at least one keyboard diagram is positioned on the display medium above or below, or any combination of above and below, each at least one staff.

29. The method of claim 28, further comprising the step of placing the piano, organ or keyboard fingering for the portion of the musical composition corresponding to the position of the at least one staff where the keyboard is positioned on the at least one keyboard diagram.

30. An article that provides musical notation for playing the piano, organ or keyboard, the article comprising:
(a) a musical composition for playing the piano, organ or keyboard, wherein the musical composition is comprised of at least one staff that is displayed on a display medium;
(b) at least one keyboard diagram; and
(c) keyboard diagram attachment means;
(d) wherein:
(i) the at least one keyboard diagram is attached by the keyboard diagram attachment means to the display medium; and
(ii) the at least one keyboard diagram is positioned on the display medium above or below, or any combination of above and below, each at least one staff.

31. The article of claim 30, wherein the at least one keyboard diagram displays the piano, organ or keyboard fingering for the portion of the musical composition corresponding to the position of the at least one staff where the keyboard diagram is positioned.

32. A stamping appliance that provides musical notation for playing the piano, organ or keyboard, the stamping appliance comprising:
(a) a stamping member, further comprising:
(i) a handle portion; and
(ii) a stamping portion further comprising a bottom stamping surface and a raised keyboard diagram pattern on the bottom stamping surface; and
(b) wherein:
(i) the raised keyboard diagram pattern on the bottom stamping surface is coated with a layer of ink;
(ii) a keyboard diagram is placed on a display medium by placing the raised keyboard diagram pattern of the bottom stamping surface adjacent to the surface of the display medium, wherein an ink facsimile of the raised keyboard diagram pattern is left on the display medium when the raised keyboard diagram pattern of the bottom stamping surface is removed from the display medium;
(iii) the display medium is comprised of a musical composition for playing the piano, organ or keyboard, wherein the musical composition is comprised of at least one staff that is displayed on the display medium; and
(iv) the facsimile keyboard diagram is positioned on the display medium above or below, or any combination of above and below, the at least one staff.

33. A stamping appliance that provides musical notation for playing the piano, organ or keyboard, the stamping appliance comprising:
(a) a stamping member, further comprising:
(i) a handle portion;
(ii) a stamping portion further comprising a bottom stamping surface and a raised keyboard diagram pattern on the bottom stamping surface; and
(b) an ink blotting pad member being saturated with ink;
(c) wherein:
(i) the bottom stamping surface of the stamping portion is placed adjacent to a blotting surface of the ink blotting pad member, wherein the raised keyboard diagram pattern on the bottom stamping surface is coated with a layer of ink, and the stamping portion is then removed from the ink blotting pad member;
(ii) a keyboard diagram is placed on a display medium by placing the raised keyboard diagram pattern of the bottom stamping surface adjacent to the surface of the display medium, wherein an ink facsimile of the raised keyboard diagram pattern is left on the display medium when the raised keyboard diagram pattern of the bottom stamping surface is removed from the display medium;
(iii) the display medium is comprised of a musical composition for playing the piano, organ or keyboard, wherein the musical composition is comprised of at least one staff that is displayed on the display medium; and
(iv) the facsimile keyboard diagram is positioned on the display medium above or below, or any combination of above and below, the at least one staff.

34. The stamping appliance of claim 33, wherein the raised keyboard diagram pattern on the bottom stamping surface of the stamping portion further comprises the piano, organ or keyboard fingering for the portion of the musical composition corresponding to the position of the at least one staff where the facsimile keyboard diagram is positioned.

35. A method of using the stamping appliance of claim 33, such method comprising the steps of:
(a) first placing the bottom stamping surface of the stamping portion adjacent to a blotting surface of the ink blotting pad member, wherein the raised keyboard diagram pattern on the bottom stamping surface is coated with a layer of ink;
(b) removing the bottom stamping surface of the stamping portion from the ink blotting pad member;
(c) momentarily placing the raised keyboard diagram pattern of the bottom stamping surface of the stamping member adjacent to the surface of a display medium on which is displayed a musical composition for playing the piano, organ or keyboard, wherein the musical composition is comprised of at least one staff that is displayed on the display medium, and wherein the raised keyboard diagram pattern is positioned above or below the at least one staff on the display medium; and
(d) removing the raised keyboard diagram pattern on the bottom stamping surface of the stamping member from the surface of the display medium, wherein a facsimile of the raised keyboard diagram pattern is left on the display medium when the raised keyboard diagram pattern on the bottom stamping surface is removed from the display medium.

36. The method of claim 35, further comprising the step of placing the piano, organ or keyboard fingering for the portion of the musical composition corresponding to the position of the at least one staff where the facsimile keyboard diagram is positioned on the facsimile keyboard diagram.

37. A stamping appliance that provides musical notation for playing the piano, organ or keyboard, the stamping appliance comprising:
(a) a handle portion further comprising an ink source; and
(b) a stamping portion positioned approximately at one end of the handle portion, the stamping portion further comprising a bottom stamping surface and a keyboard diagram pattern on the bottom stamping surface;
(c) wherein:
(i) the stamping portion is placed adjacent to the ink source, wherein there is a layer of ink on the keyboard diagram pattern on the bottom stamping surface as a result of such contact of the stamping portion with the ink source;
(ii) a keyboard diagram is placed on a display medium by momentarily placing the keyboard diagram pattern on the bottom stamping surface adjacent to the surface of the display medium, wherein an ink facsimile of the keyboard diagram pattern is left on the display medium when the keyboard diagram pattern on the bottom stamping surface is removed from the display medium;
(iii) the display medium is comprised of a musical composition for playing the piano, organ or keyboard, wherein the musical composition is comprised of at least one staff that is displayed on the display medium; and
(iv) the facsimile keyboard diagram is positioned on the display medium above or below, or any combination of above and below, the at least one staff.

38. The stamping appliance of claim 37, wherein the keyboard diagram pattern on the bottom stamping surface of the stamping portion further comprises the piano, organ or keyboard fingering for the portion of the musical composition corresponding to the position of the at least one staff where the facsimile keyboard diagram is positioned.

39. A method of using the stamping appliance of claim 37, such method comprising the steps of:
(a) first momentarily placing the keyboard diagram pattern of the bottom stamping surface of the stamping appliance adjacent to the surface of the display medium on which is displayed the musical composition for playing the piano, organ or keyboard, wherein the musical composition is comprised of at least one staff that is displayed on the display medium, and wherein the keyboard diagram pattern is positioned above or below the at least one staff on the display medium; and
(b) removing the keyboard diagram pattern on the bottom stamping surface of the stamping appliance from the surface of the display medium, wherein an ink facsimile of the keyboard diagram pattern is left on the display medium when the keyboard diagram pattern on the bottom stamping surface is removed from the display medium.

40. The method of claim 39, further comprising the step of placing the piano, organ or keyboard fingering for the portion of the musical composition corresponding to the position of the at least one staff where the facsimile keyboard diagram is positioned on the facsimile keyboard diagram.
